(19) United States
(12) Patent Application Publication
(10) Pub. No.: US 2019/0031979 A1
(43) Pub. Date: Jan. 31, 2019

(54) HYDROGEL MATERIAL THAT MAY BE USED FOR THE SEQUESTRATION OF ORGANOPHOSPHORUS COMPOUNDS

(71) Applicant: COMMISSARIAT À L'ÉNERGIE ATOMIQUE ET AUX ÉNERGIES ALTERNATIVES, Paris (FR)

(72) Inventors: Stéphane CADRA, Saint Avertin (FR); Hervé GALIANO, Bruyeres-Le-Chatel (FR); Benoit BLONDEL, Chambray-Les-Tours (FR)

(21) Appl. No.: 16/073,517

(22) PCT Filed: Jan. 26, 2017
(86) PCT No.: PCT/EP2017/051670

§ 371 Date: Jul. 27, 2018

(30) Foreign Application Priority Data
Jan. 29, 2016 (FR) 16 50722

(51) Int. Cl. C11D 3/37

(52) U.S. Cl. CPC C11D 3/3769

(57) ABSTRACT

A specific hydrogel material for decontaminating areas comprising organophosphorus compounds.

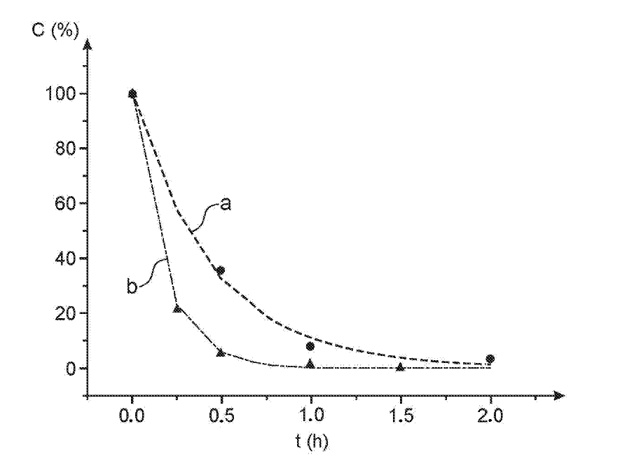

### TECHNICAL FIELD

The present invention relates to the use of hydrogel materials having specific properties for the sequestration of organophosphorus chemical compounds, to a method of trapping or sequestering such compounds, as well as to specific hydrogel materials for the sequestration of such compounds.

Because of their sequestering properties, these hydrogel materials may be used in the decontamination of media including organophosphorus compounds, for example, in certain environments, such as the chemical industry, agriculture, or in industries that fight against chemical gas attacks.

In general, the organophosphorus compounds present in these environments are in the form of organic compounds having a proven toxicity for the human body, wherein the average lethal concentration by inhalation may be at least 10 mg·min·m⁻³, as described in J. Org. Chem. 1996, 61, 8407-8413. In fact, these compounds may be involved in the acetylcholinesterase inhibition mechanism preventing muscle relaxation and may cause death by asphyxiation.

These compounds may be included in the formulation of insecticides, pesticides or warfare chemical agents and are conventionally in the form of water-soluble oily organic compounds which, once dispersed in the environment, have a half-life in water ranging from 5 hours to 80 hours, with the risk, however, that products resulting from hydrolysis degradation in water remain toxic for 30 to 60 days.

In view of their toxicity, a great deal of research has been undertaken to develop curative solutions to the threats related to organophosphorus compounds, wherein one of the lines of research aims to find systems to catalyze the degradation process of these compounds, in order to quickly render them inactive.

These decontamination systems are generally in the form of liquids or powders in the form of sprays or in the form of a liquid soaked in a sponge, wherein the active ingredients at the origin of the decontamination may be of inorganic or organic origin.

As examples of inorganic active principles, mention may be made of alkaline solutions, such as sodium hydroxide solutions (NaOH), potassium hydroxide solutions (KOH) and ammonium hydroxide solutions (NH₄OH), which were the first decontaminant solutions to be studied at the end of the 1950s, because of their effectiveness with respect to warfare organophosphorus compounds, such as sarin gas or soman gas, which fall into the category of G-type neurotoxics, wherein such systems are described in Act. Chem. Scand. 1957, 11, 1131-1142.

From the point of view of the mechanism of action of these alkaline solutions with respect to the organophosphorus compounds, it has been demonstrated that they make it possible to increase the kinetics of hydrolysis of the sarin and soman gases by increasing the pH value of the medium, wherein the half-life is reduced to 8 minutes in basic medium. On the other hand, the use of alkaline solutions proves ineffective with respect to more persistent organophosphorus compounds, such as V-type neurotoxic agents (and more specifically VX and VR-55 agents).

For these V-type neurotoxic agents, new solutions have been proposed, as described in J.Org. Chem. 2009, 74, 329-338, where, to improve the hydrolysis of these agents, it is proposed to adsorb them on a powder mixture composed of potassium fluoride (KF) and alumina (Al₂O₃), wherein this mixture allows, in the presence of water, the generation of potash (KOH), which induces an increase in the pH of the medium.

As examples of organic active principles, it has been proposed to use α-nucleophilic organic compounds, i.e. a compound comprising a nucleophilic group adjacent to an atom carrying an electron doublet, wherein the doublet has the effect of reinforcing the nucleophilic character of the compound. Compounds meeting this definition and effective for the decontamination of a medium comprising organophosphorus compounds such as G- or V-type agents, are oximate compounds, such as 2,3-butanedione monoxime.

As an alternative, it has also been proposed to integrate these oximate functions directly into a polymer, for example, starting from a base polymer of the polyacrylonitrile type. The amidoximate groups thus generated have a high nucleophilic character with a pKa of the order of 11 to 12 (against 8, in the case of conventional oximes), as described in Ind.Eng.Chem.Res. 2009, 48, 1650-1659, wherein the resulting polymers have a high efficiency in dispersion in water with respective half-life durations of 5 minutes and less than 3 minutes for VX gas and sarin gas.

In summary, existing systems for the decontamination of media comprising organophosphorus compounds are in the form of powders or liquids, or even suspensions, which need to be projected onto the zone to be decontaminated and, consequently, the provision of projection devices.

Also, in view of what exists, the inventors have proposed the development of new systems for use in the decontamination of organophosphorus compounds, and which do not need to be projected onto the zone to be decontaminated, in particular through projection devices.

### DESCRIPTION OF THE INVENTION

Thus, the invention relates to the use for the sequestration or trapping of at least one organophosphorus compound, of a hydrogel material comprising a polymer and an aqueous phase comprising an agent capable of generating the sequestration of an organophosphorus compound in the hydrogel material, wherein, advantageously, the agent is a salt selected from alkali halides, alkaline phosphates, alkali sulfates and mixtures thereof, wherein the aqueous phase is trapped in the polymer.

Before going into more detail in the description of this invention, the following definitions as used herein are defined.

By “hydrogel material” is meant a material in the form of a gel consisting of a polymer in which is retained an aqueous phase, which conventionally corresponds to the polymerization medium (i.e. the medium in which the polymerization takes place to form the constituent polymer of the hydrogel material). Due to the flexibility of the polymer network constituting the hydrogel, such a material is conventionally capable of absorbing a mass of water that may exceed 100 times the mass of the polymer structure.

For the purposes of the invention, the term “polymer” conventionally means a compound consisting of the linking of one or more repeating units.

By “repeating unit” is meant, conventionally and within the meaning of the invention, a divalent organic group (i.e. a bridging group) derived from a monomer after polymerization thereof, wherein the formula of the repeating unit corresponds to that of the monomer whose double bond has been replaced by two hydrogen atoms borne by the carbon atoms bearing the double bond in the monomer.

Advantageously, the constituent polymer of the hydrogel material is a hydrophilic polymer, i.e. it is capable of storing water, wherein such a property is made possible by the presence of polar groups capable of forming hydrogen bonds, all the more so in this case, with water.

In addition, the polymer advantageously comprises groups capable of forming hydrogen bonds and, more specifically, groups comprising one or more hydrogen atoms bonded to atoms that are more electronegative than hydrogen, such as nitrogen atoms, oxygen atoms, halogen atoms, such as fluorine.

Even more specifically, the polymer may include groups selected from amide groups, —OH groups, carboxylic groups and/or carboxylate groups.

While not excluding the characteristics defined above for this polymer, the polymer may advantageously be a polymer comprising, in its chain, at least one repeating unit resulting from the polymerization of a nonionic monomer and at least one repeating unit derived from the polymerization of an ionic monomer, wherein it should be noted that a nonionic monomer is a monomer devoid of at least one ionic group, i.e. a group carrying an anionic charge or a cationic charge associated with a counter-ion of opposite charge while, conversely, an ionic monomer is a monomer bearing one or more ionic groups as defined above.

The repeating unit resulting from the polymerization of a nonionic monomer may be a unit resulting from the polymerization of a vinyl monomer, and, more specifically, from a monomer chosen from styrene monomers, acrylate monomers (and, more particularly, alkyl acrylate monomers), methacrylate monomers (and, more particularly, alkyl methacrylate monomers), acrylamide monomers (and more particularly, alkyl acrylamide monomers), with, for preference, acrylamide monomers, and, also more particularly, alkyl acrylamide monomers.

By way of example, the repeating unit resulting from the polymerization of an alkyl acrylamide monomer has the following formula (I):

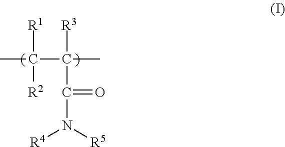

in which R¹, R², R³, R⁴ and R⁵ correspond, independently of one another, to a hydrogen atom or an alkyl group, and preferably, with the proviso that at least one of the R⁴ group or R⁵ group is an alkyl group.

More specifically, the repeating unit resulting from the polymerization of an alkyl acrylamide monomer has the following formula (II):

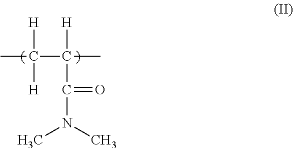

wherein this repeating unit is derived from the polymerization of the N, N′-dimethylacrylamide monomer.

The repeating unit resulting from the polymerization of a nonionic monomer is preferably comprised in the polymer in a proportion of at least 50% by weight relative to the total weight of the polymer.

The repeating unit resulting from the polymerization of an ionic monomer may be a unit resulting from the polymerization of a vinyl monomer bearing at least one ionic group, such as:
an anionic group, and more specifically, a carboxylate group, a phosphonate group (resulting from the deprotonation of a phosphonic acid group) or a sulphonate group (derived from the deprotonation of a sulphonic acid group); or
a cationic group, and, more specifically, an ammonium group (resulting from the protonation of an amine group).

By way of example, the repeating unit resulting from the polymerization of an ionic monomer is a repeating unit resulting from the polymerization of a specific (meth)acrylate monomer corresponding to the following formula (III):

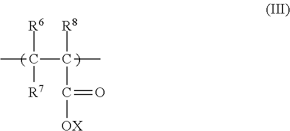

wherein R⁶, R⁷, R⁸ correspond, independently of one another, to a hydrogen atom or an alkyl group, while X represents a cation, such as an alkaline cation, an ammonium cation.

A specific unit coming under the definition of the units of formula (III) is the repeating unit of formula (IV) below:

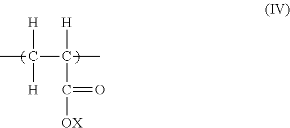

wherein X is an alkaline cation, in particular sodium or potassium, in which case this repeating unit is derived respectively from the polymerization of sodium acrylate or potassium acrylate.

The repeating unit resulting from the polymerization of an ionic monomer is comprised in the polymer, preferably at most 50% by weight relative to the total weight of the polymer.

In particular, a polymer capable of advantageously entering into the constitution of the hydrogel material of the invention is a polymer comprising a repeating unit of formula (I) as defined above and a repeating unit of formula (III) as defined above and, more specifically, a polymer comprising a repeating unit of formula (II) and a repeating unit of formula (IV).

The aqueous phase comprising the agent capable of generating the sequestration of an organophosphorus compound in the hydrogel material may correspond to:
the polymerization medium, in which the polymer has been synthesized and in which the agent has been added; or
an aqueous phase having substituted all or part of the polymerization medium, and in which the agent has been added.

In the latter case, the aqueous phase having substituted all or part of the polymerization medium may be ultrapure water.

As to the agent, it may advantageously be a salt selected from alkali halides, alkaline phosphates, alkali sulfates and mixtures thereof, such as, for example, potassium fluoride.

From a structural point of view, the hydrogel material is advantageously in the form of a membrane, for example, a planar membrane having a thickness ranging from 1 mm to 2 cm, wherein the membrane may perform a patch function.

The hydrogel materials that may be used in accordance with the invention may be prepared by a method comprising the following steps:
a) a step of polymerizing, in an aqueous polymerization medium, one or more monomers, after which a hydrogel material is formed trapping the aqueous polymerization medium;
b) a step of bringing the hydrogel material thus formed into contact with an aqueous medium comprising an agent capable of generating the sequestration of an organophosphorus compound in the hydrogel material, wherein the agent diffuses into the hydrogel material.

The monomer(s) mentioned above may be monomers as defined above in the context of the definition of the hydrogel materials of the invention.

This polymerization step is carried out advantageously in the presence of a radical polymerization initiator.

Conventionally, a radical polymerization initiator is a chemical compound capable of initiating a polymerization reaction by generation of free radicals. From the point of view of the reaction mechanism, the initiator binds to a monomer via a vinyl function and thereby activates the latter by electron transfer. The new compound so formed will continue its growth by binding and activating another monomer present in the medium and so on, until all the monomers have reacted or even until the neutralization of the free radicals.

The radical polymerization initiator may be thermally activated (in which case it is a thermal initiator) or by irradiation with a specific wavelength (in which case it is a photo initiator).

As examples of a thermal initiator, mention may be made of persulfate compounds, such as potassium persulfate, sodium persulfate or ammonium persulfate.

The radical polymerization initiator may be included in the aqueous polymerization medium in a proportion of 0.2% to 5% per mole relative to the total number of moles of monomers.

The polymerization step may be implemented by the following operations:
an operation for forming a prepolymer under an inert atmosphere and with stirring for a period appropriate for the formation of this prepolymer;
an operation for sampling this prepolymer, for example, via a syringe;
a transfer operation of this prepolymer in a mold placed in an enclosure under an inert atmosphere for a period appropriate for the completion of the polymerization.

Regarding the prepolymer, it should be noted that a polymer is being formed (i.e. for which the polymerization is not completed), wherein it should be noted that this prepolymer must have a viscosity value that is sufficiently low to allow its removal in the subsequent operation and its transfer during the final operation.

In an inert atmosphere, it is specified that, in order to obtain it, the polymerization medium is previously degassed by bubbling with an inert gas, wherein the reactor in which the prepolymerization operation takes place, or the chamber in which the transfer operation takes place, is previously purged with the same inert gas, wherein the latter may be argon or nitrogen.

The appropriate time for the formation of the prepolymer is preferably the time after the pooling of the reagents, beyond which the prepolymer shall have reached a viscosity threshold, beyond which syringe sampling is no longer possible, wherein this appropriate duration may be a few hundred seconds, for example, 150 seconds ±10 seconds.

The mold of the transfer operation has a shape corresponding to the desired shape of the hydrogel material, for example, a flat membrane shape, and may be made of a silicone material or a polytetrafluoroethylene (PTFE) material.

After the polymerization (which may last up to 24 hours), the hydrogel material is demolded, and then undergoes the contacting step b).

This contacting step b) may be carried out in a container, for example made of PTFE, filled with an aqueous medium (for example, ultrapure water) comprising the agent capable of generating the sequestration of an organophosphorus compound in the hydrogel material, such as a salt selected from alkali halides, alkaline phosphates, alkali sulfates and mixtures thereof.

Without being bound by the theory, such a salt will contribute to increasing the ionic strength of the swollen hydrogel material following the absorption of the aqueous solution, wherein this results in an increase in the sequestering capacity of the hydrogel material for the organophosphorus compound by osmotic pressure. In addition, this type of salt may have neutralizing properties for certain organophosphorus compounds, such as sarin gas or VX gas.

The amount of the aforementioned agent used may be up to 10% by weight of the aqueous medium.

The aqueous medium may, for its part, be used in a mass quantity ranging from 4 to 17 times the mass of the dry hydrogel material, i.e. the mass of the hydrogel material without water.

As mentioned above, the hydrogel materials used in accordance with the invention are, by their ingredients, capable of sequestering or trapping organophosphorus compounds.

In addition, the invention also relates to a method for trapping an organophosphorus compound present in a zone contaminated with the organophosphorus compound, wherein it comprises a step of contacting a hydrogel material as defined above for use in the contaminated zone followed by a step of removing the material from the zone, wherein the zone is thus depleted or even deprived of the organosphosphorus compound.

More specifically, the contacting step may consist in depositing the hydrogel material, for example, in the form of a membrane, on the contaminated zone and in removing it easily and quickly, without it being necessary to resort to suction systems.

Among the hydrogel materials subject to the use and method of the invention, some are new.

In addition, the invention also relates to a hydrogel material comprising a polymer and an aqueous phase comprising an agent capable of generating the sequestration of an organophosphorus compound in the hydrogel material, wherein the agent is potassium fluoride, and wherein the aqueous phase is trapped in the polymer.

It should be noted that the other characteristics of the material, in particular as regards the constituent polymer, may be those already defined above in the context of use.

The invention will now be described in the light of the examples below, wherein these examples are provided by way of illustration of the invention and in no way constitute a limitation.

### BRIEF DESCRIPTION OF THE DRAWINGS

The single FIGURE is a graph illustrating the evolution of the residual DMMP concentration C (expressed in %) as a function of the contact time t (in hours).

### DETAILED PRESENTATION OF PARTICULAR EMBODIMENTS

### Example 1

This example illustrates the preparation of a hydrogel material used subsequently for the design of a hydrogel material according to the invention.

To do this, sodium acrylate (1.242 g) is introduced into a 30 ml container, previously dried overnight at 90° C. in a vacuum oven dynamic and conditioned under argon.

A magnetic bar is added to the container, which is then sealed with a septum and purged with argon.

N, N′-dimethylacrylamide (5.44 ml) is added through the septum, followed by ultrapure water (13.4 ml).

The resulting mixture is stirred under magnetic stirring and under inert gas for 15 minutes until a clear solution is obtained.

The septum is then removed, and potassium persulfate (35.8 mg) is immediately added to the container. The septum is put back in place and the container is subjected to a new purge under argon and with stirring.

About 150 seconds after the introduction of potassium persulfate, the septum is removed again and the now entirely polymerized mixture is removed using a syringe.

Deposits of the formed polymer are made in flat-bottomed 25 ml polytetrafluoroethylene (PTFE) cups at a rate of 3.5 ml per cup. The cups thus filled are introduced into a hermetic enclosure with a gas flow. A nitrogen sweep is carried out for 2 hours.

At the end of these two hours, the nitrogen flow is interrupted. The cups are kept overnight in the chamber under a nitrogen atmosphere. The next day, the hydrogel materials in the cups are removed and stored on a silicone plate in a dust-free place for 24 hours (in this case, an upside-down crystallizer with a light passage of air).

### Example 2

In this example, the hydrogels obtained in Example 1 are swollen.

To do this, 25 ml of ultrapure water is introduced into a 25 ml PTFE cup.

A hydrogel material of Example 1 is then immersed in the cup for 24 hours, so that all of the aqueous phase is incorporated into the material.

### Example 3

In this example, the procedure is the same as in Example 2, except that the volume of ultrapure water is increased to 10 ml.

### Example 4

In this example, the procedure is the same as in Example 2, except that the volume of ultrapure water is increased to 15 ml.

### Example 5

In this example, the procedure is the same as in Example 2, with the difference that the aqueous phase used consists of 5 ml of ultrapure water, in which 2.5% by weight of potassium fluoride is dissolved.

### Example 6

In this example, the procedure is the same as in Example 2, with the difference that the aqueous phase used consists of 5 ml of ultrapure water, in which 5% by weight of potassium fluoride is dissolved.

### Example 7

In this example, the procedure is the same as in Example 2, with the difference that the aqueous phase used consists of 5 ml of ultrapure water, in which 10% by weight of potassium fluoride is dissolved.

### Example 8

In this example, the procedure is the same as in Example 2, with the difference that the aqueous phase used consists of 10 ml of ultrapure water, in which 2.5% by weight of potassium fluoride is dissolved.

### Example 9

In this example, the procedure is the same as in Example 2, except that the aqueous phase used consists of 10 ml of ultrapure water, in which are dissolved 5% by weight of potassium fluoride.

### Example 10

In this example, the procedure is the same as in Example 2, with the difference that the aqueous phase used consists of 10 ml of ultrapure water, in which 10% by weight of potassium fluoride is dissolved.

### Example 11

In this example, the objective is to demonstrate the sequestering properties of the materials of the invention for the organophosphorus compounds.

In order to do this, the absorption kinetics of the swollen hydrogel are measured when it is deposited directly on a volume comprising an organosphosphorus compound, wherein these conditions are the most representative of a real environment, namely direct contact with a contaminated surface.

The organophosphorus compound used is a compound that simulates warfare chemical agents (such as sarin gas), in that it has similar physicochemical properties (in terms, in particular, of boiling point and solubility) while presenting less toxicity.

This organophosphorus compound is dimethyl methyl-phosphonate (symbolized by the abbreviation DMMP).

The kinetic monitoring is carried out by indirect determination of the organophosphorus compound as a function of the duration of contacting, wherein this measurement is carried out by gas chromatography coupled to a mass spectrometer (GC-MS).

At first, the following operation is implemented for the determination of the point T0.

To do this, 0.25 ml of DMMP is introduced into a 50 ml PTFE cup. The cup is then rinsed twice with 5 ml of ethanol. The two washing phases are combined, then 1 ml is sampled and introduced into the GC-MS feeder. After recording the corresponding chromatogram, the DMMP signal is identified and the value of its area is recorded. This value T0, which corresponds to the area relating to the initial concentration of DMMP, is used as a basis of comparison for the rest of the protocol.

In a second step, 0.25 ml of DMMP per cup is introduced in 4 50 ml PTFE cups. Four samples of hydrogel material from Example 2 are then positioned in each cup comprising DMMP.

After 15 minutes of contact, the hydrogel material of the first cup is removed. The cup is then rinsed twice with 5 ml of ethanol. The two washing phases are combined, then 1 ml is taken and introduced into the GC-MS feeder. A chromatogram is then recorded and the area value of the DMMP signal is measured and compared to the measurement T0.

Finally, in a third step, the operation is then reproduced with the following 3 cups, with respective contacting durations of 30 minutes, 1 hour and 2 hours.

The results are plotted on curve a) of the single FIGURE attached in the appendix which illustrates the evolution of the residual DMMP concentration C (expressed in %) as a function of the contact time t (in hours).

In parallel, the operations were repeated in the same way but with the hydrogel material of Example 6, i.e. the hydrogel material, for which the aqueous phase used consists of 5 ml of ultrapure water, in which 5% by weight of potassium fluoride is dissolved.

The results are shown in curve b) of the single FIGURE in the appendix.

As a comparison, it may be seen that, in 1 hour, the amount of residual DMMP was measured at 8% of the initial value in the case of contact with the material of Example 2, whereas, in the case of the material of Example 6, the amount of residual DMMP after one hour was measured at 1.5%, which corresponds to an absorption of 98.5%.

This confirms the effectiveness of the materials of the invention for the absorption of organophosphorus compounds.

What is claimed is:

1-20. (canceled)

21. Method for trapping an organophosphorus compound present in a zone contaminated with the organophosphorus compound comprising a step of contacting a hydrogel material comprising a polymer and an aqueous phase comprising an agent capable of generating the sequestration of an organophosphorus compound in the hydrogel material, wherein the agent is a salt selected from alkali halides, alkaline phosphates, alkali sulfates and mixtures thereof, with the contaminated zone followed by a step of removing the material from the zone, wherein the zone is thus depleted or even deprived of the organosphosphorus compound.

22. Method according to claim 21, wherein the polymer comprises groups capable of forming hydrogen bonds.

23. Method according to claim 21, wherein the polymer comprises groups selected from amide groups, —OH groups, carboxylic groups and/or carboxylate groups.

24. Method according to claim 21, wherein the polymer comprises at least one repeating unit resulting from the polymerization of a nonionic monomer and at least one repeating unit resulting from the polymerization of an ionic monomer.

25. Method according to claim 24, wherein the repeating unit resulting from the polymerization of a nonionic monomer is a repeating unit resulting from the polymerization of a monomer chosen from styrene monomers, acrylate monomers, methacrylate monomers, acrylamide monomers.

26. Method according to claim 24, wherein the repeating unit resulting from the polymerization of a nonionic monomer is a repeating unit resulting from the polymerization of an alkyl acrylamide monomer.

27. Method according to claim 24, wherein the repeating unit resulting from the polymerization of a nonionic monomer is a unit corresponding to the following formula (I): 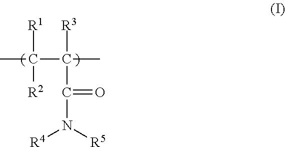
in which R1, R2, R3, R4 and R5 correspond, independently of one another, to a hydrogen atom or an alkyl group, and preferably, with the proviso that at least one of the R4 group or R5 group is an alkyl group.

28. Method according to claim 24, wherein the repeating unit resulting from the polymerization of a nonionic monomer is a unit corresponding to the following formula (II):

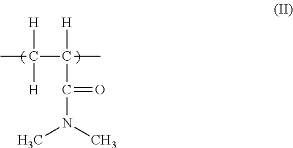

29. Method according to claim 24, wherein the repeating unit resulting from the polymerization of a nonionic monomer is included in the polymer by at least 50% by weight relative to the total mass of the polymer.

30. Method according to claim 24, wherein the repeating unit resulting from the polymerization of an ionic monomer is a unit resulting from the polymerization of a vinyl monomer bearing at least one ionic group.

31. Method according to claim 30, wherein the ionic group is an anionic group or a cationic group.

32. Method according to claim 24, wherein the repeating unit resulting from the polymerization of an ionic monomer is a repeating unit resulting from the polymerization of a monomer (meth) acrylate corresponding to the formula (III): 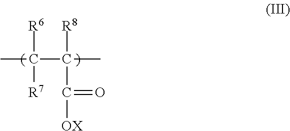
wherein R6, R7, R8 correspond, independently of one another, to a hydrogen atom or an alkyl group, while X represents a cation, such as an alkaline cation, an ammonium cation.

33. Method according to claim 24, wherein the repeating unit resulting from the polymerization of an ionic monomer is a repeating unit of formula (IV): 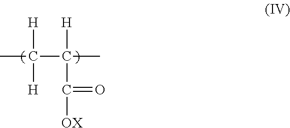
wherein X is an alkaline cation, in particular sodium or potassium, wherein this repeating unit is derived respectively from polymerization of sodium acrylate or potassium acrylate.

34. Method according to claim 24, wherein the repeating unit resulting from the polymerization of an ionic monomer is included in the polymer at a rate of at most 50% by weight relative to the total weight of the polymer.

35. Method according to claim 24, wherein the polymer is a polymer comprising:
a repeating unit of formula (I): 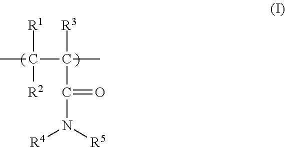
in which R1, R2, R3, R4 and R5 correspond, independently of one another, to a hydrogen atom or an alkyl group, and preferably, with the proviso that at least one of the R4 group or R5 group is an alkyl group; and
a repeating unit of formula (III): 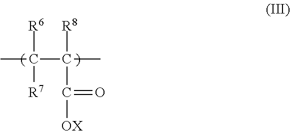
wherein R6, R7, R8 correspond, independently of one another, to a hydrogen atom or an alkyl group, while X represents a cation, such as an alkaline cation, an ammonium cation.

36. Method according to claim 24, wherein the polymer is a polymer comprising:
a repeating unit of formula (II): 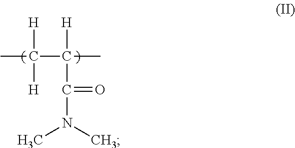
and
a repeating unit of formula (IV): 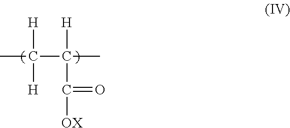
wherein X is an alkaline cation, in particular sodium or potassium, wherein this repeating unit is derived respectively from polymerization of sodium acrylate or potassium acrylate.

37. Method according to claim 21, wherein the agent is potassium fluoride.

38. Method according to claim 21, wherein the hydrogel material is in the form of a membrane.

39. Hydrogel material comprising a polymer and an aqueous phase comprising an agent capable of generating sequestration of an organophosphorus compound in the hydrogel material, wherein the agent is potassium fluoride, and wherein the aqueous phase is trapped in the polymer.
